(19) United States
(12) Patent Application Publication
(10) Pub. No.: US 2026/0103131 A1
(43) Pub. Date: Apr. 16, 2026

(54) VEHICLE SEAT

(71) Applicant: GRAMMER Aktiengesellschaft, Ursensollen (DE)

(72) Inventors: KONSTANTIN KRIVENKOV, Amberg (DE); KONSTANTIN LOREY, Schmidgaden (DE); MICHAEL ZÖLLNER, Velburg (DE); JASTY PHANENDRA, Aschaffenburg (DE)

(21) Appl. No.: 19/322,882

(22) Filed: Sep. 9, 2025

(30) Foreign Application Priority Data
Oct. 15, 2024 (DE) 102024129911.8

(51) Int. Cl. B60N 2/806; B60N 2/22

(52) U.S. Cl. CPC B60N 2/806; B60N 2/2222

(57) ABSTRACT

A vehicle seat for a commercial vehicle includes a seat part and a backrest, which has a lower part of the backrest and an upper part of the backrest. The upper part of the backrest is displaceable relative to the lower part of the backrest. A sliding device is fixedly arranged on the lower backrest part. The upper backrest part at least partially encloses the sliding device and is arranged so as to be displaceable along a direction of displacement. The upper backrest part includes two shell elements firmly connected to each other, between which the sliding device is arranged. At least two inner runners are arranged on each shell element or are formed by the respective shell element. The sliding device contacts the inner runners and is slideable along them.

### CROSS-REFERENCE TO RELATED APPLICATIONS

This application claims priority to German Patent Application 102024129911.8 filed on Oct. 15, 2024, the contents of which are incorporated by reference herein in their entirety.

### TECHNICAL FIELD

The invention relates to a vehicle seat, in particular for a commercial vehicle, comprising a seat part and a backrest, which comprises a lower part of the backrest and an upper part of the backrest, wherein the upper part of the backrest is displaceable relative to the lower part of the backrest.

### BACKGROUND

Such vehicle seats are suitable for commercial vehicles, agricultural vehicles such as tractors, construction machinery, industrial trucks, forklift trucks or similar vehicles. Drivers of such commercial vehicles often adopt a seating position that differs from the normal seating position, which is facing forwards, i.e. in the direction of travel. This alternative seating position is oriented to the side and/or rear and serves, for example, to better reach and operate controls that are located to the side and/or rear of the vehicle cab. Furthermore, the alternative seating position can serve to better observe a work implement attached behind the agricultural utility vehicle for a longer period of time. Of course, the alternative seating position is also adopted when reversing. In order to enable or facilitate the adoption of such a wider seating position, vehicle seats are known from the prior art in which the entire upper part of the backrest is designed to be movable sideways. The occupant can thus push the upper part of the backrest away during the turning movement, thereby having more space available and, if necessary, experiencing support for the back in the wider seating position. However, a disadvantage of the prior art is that the displacement function requires corresponding guide devices, which means that the upper parts of the backrests must be comparatively large. The provision of the guide devices also limits the design options. Furthermore, the guide devices are comparatively expensive.

The invention provides a vehicle seat in which the aforementioned disadvantages are overcome or at least reduced.

### SUMMARY

The core idea of the invention is a vehicle seat, in particular for a commercial vehicle, comprising a seat part and a backrest, which comprises a lower part of the backrest and an upper part of the backrest, wherein the upper part of the backrest is displaceable relative to the lower part of the backrest, wherein a sliding device is fixedly arranged on the lower part of the backrest, wherein the upper part of the backrest at least partially encloses the sliding device and is arranged so as to be displaceable along a direction of displacement (V), wherein the upper part of the backrest comprises two shell elements firmly connected to each other, between which the sliding device is arranged, wherein at least two inner runners are arranged on each shell element or are formed by the respective shell element, wherein the sliding device contacts the inner runners and can slide along them.

The lower part of the backrest and the upper part of the backrest are designed and suitable for supporting a passenger. Advantageously, the lower part of the backrest and the upper part of the backrest together form the backrest.

The vehicle seat extends along a width axis (Y), a longitudinal axis (X) and a height axis (Z). In the normal sitting position mentioned above, the occupant is facing forwards along the longitudinal axis (X). The backrest is arranged at or behind a rear end of the seat part along the longitudinal axis (X) and extends upwards from the seat part along the height axis (Z). Advantageously, the upper part of the backrest is arranged above the lower part of the backrest along a height axis (Z).

Compared to the prior art, the upper part of the backrest according to the invention has a simplified structure, which enables simplified assembly of the upper part of the backrest. The upper part of the backrest according to the invention can also be constructed comparatively narrow. The use of the shell elements also enables greater design possibilities for the backrest, as the outer surfaces of the shell elements can be designed as desired. If necessary, the shell elements offer the possibility of arranging additional elements on them.

The backrest upper section according to the invention enables the lateral displacement function to be provided even in simpler/cost-effective backrests. On the other hand, the backrest upper section according to the invention can also be placed in smaller vehicle cabins, thereby contributing to the health of as many drivers as possible.

The arrangement of the sliding device between the shell elements advantageously results in a sandwich-like structure consisting of a section of the upper part of the backrest and the sliding device. Preferably, the sliding device is designed in the form of a sheet. The sliding device therefore extends considerably further along the height axis (Z) and along the width axis (Y) than along a longitudinal axis (X). Advantageously, the two shell elements are arranged relative to each other in such a way that a space is created between them. The sliding device moves relative to the shell elements in this clearance. The sliding device therefore requires only a small amount of space between the front and rear shell elements. The upper part of the backrest can thus be constructed to be extremely narrow.

Advantageously, the lateral direction of displacement (V) lies in a plane spanned by a width axis (Y) and a longitudinal axis (X). Preferably, the lateral direction of displacement (V) is essentially along the width axis (Y). The lateral direction of displacement (V) can extend in a straight line along the width axis (Y). However, the lateral direction of displacement (V) can also be a curved direction in the plane. In the case of such a curved direction, displacement occurs along the width axis Y but also along the longitudinal axis (X). In the case of such a curved direction, this is generally a rotational movement around the height axis (Z). However, the radius of the displacement curve or the curved direction is so large that the component along the longitudinal axis (X) is small in comparison to the component along the width axis (Y). A lateral direction of displacement (V) essentially along the width axis (Y) should therefore comprise a displacement that is linear along the width axis (Y) as well as the described displacement along a curved direction, which has a much larger component along the width axis (Y) than along the longitudinal axis (X).

According to an advantageous embodiment, each of the shell elements is designed as a single piece. A single-piece design means that all sections of the shell element are manufactured from a single, uniform part. However, it would also be conceivable for each of the shell elements to be manufactured from several components. The respective components are connected by means of suitable, advantageous connections. These connections can be material-fitting (material bond) and/or form-fitting connections. It would also be conceivable for each of the shell elements to be formed in one piece from several components. A single-piece design means that although not all sections of the shell element are made from a single, uniform part, they are connected not only firmly but also so closely that they do not appear to be several components joined together and, in any case, cannot be separated from each other without being destroyed in the process.

The runners can be formed on the inner surface of the respective shell element or integrated into its inner surface. Alternatively or cumulatively, the runners can be arranged as a separate element on the inner surface of the respective shell element. This can be done using common connection types.

According to an advantageous embodiment, the shell elements and/or the sliding device are made of plastic. Advantageously, the shell elements and/or the sliding device are made of glass fibre reinforced plastic. Such plastics exhibit particularly high stability. Furthermore, components made of such plastics can be manufactured easily and cost-effectively.

According to another advantageous embodiment, the two shell elements extend essentially over the entire height along the height axis (Z) and the entire width along the width axis (Z) of the upper part of the backrest. However, embodiments in which additional elements are attached to the shell elements would also be conceivable. In this case, the aforementioned height and width of the upper part of the backrest would not be determined by the shell elements alone.

According to another advantageous embodiment, a front shell element and a rear shell element are provided. The front shell element is thus preferably arranged closer to the occupant along the longitudinal axis (X) than the rear shell element. Preferably, the front shell element comprises an upper section which extends rearwards along the longitudinal axis (X) over the sliding device. Advantageously, the front shell element further comprises a support section which is designed and suitable for supporting the occupant. The support section is connected to the upper section and forms an angle β with it. The angle β is preferably in a range between 75° and 115°, and more preferably between 85 and 110°. Advantageously, the front shell element thus has a substantially L-shaped cross-section.

According to another advantageous embodiment, reinforcement elements are arranged on the upper section. Preferably, the reinforcement elements are designed as rib elements. Preferably, the rib elements are arranged in two areas. The two areas are separated by a centre axis which runs centrally through the upper section of the front shell element. Within these areas, the respective rib elements are arranged essentially parallel to one another. The rib elements in a first area form an angle α with an axis which runs parallel to the centre axis. Advantageously, the angle α lies in a range between 10° and 60°, preferably in a range between 20° and 45°. In a second area, the respective rib elements preferably form an angle −α with an axis that runs parallel to the centre axis. The rib elements of the second range thus advantageously form an angle which lies in a range between −10° and −60°, preferably in a range between −20° and −45°. The rib elements of the first range and of the second range which are closest to the centre axis are thus preferably arranged in a V-shape.

According to another advantageous embodiment, at least one padding element is arranged at least in sections on the front shell element. Advantageously, the at least one padding element is arranged on the support section. The at least one padding element may also extend over the upper section. The at least one cushioning element may advantageously comprise at least one cushioning layer, which may consist, for example, of a foam material. Furthermore, the cushioning element may comprise a cover. Of course, further layers may also be provided.

Advantageously, at least one cover element is arranged on the rear shell element. It is conceivable that further elements are provided between the rear shell element and the cover element. Advantageously, lettering and/or a logo may be arranged on the cover element. Preferably, the cover element has a C-shaped cross-section. Preferably, the upper section of the front shell element extends flush over an upper section of the cover element. Advantageously, the upper section of the front shell element and the upper section of the cover element are flush. It would be conceivable for the upper section of the cover element to be attached to the upper section of the front shell element.

According to another advantageous embodiment, the sliding device is arranged in a lateral area of the lower part of the backrest. Accordingly, the sliding device is preferably arranged off-centre on the lower part of the backrest. The sliding device is advantageously arranged at or near a lateral boundary of the lower part of the backrest. This arrangement of the sliding device in a lateral area of the lower part of the backrest allows the upper part of the backrest to assume a basic position in which it is arranged centrally above the lower part of the backrest. Advantageously, in this basic position, the sliding device can rest against at least one of the shell elements. Advantageously, in a second position of the upper part of the backrest, in which the upper part of the backrest is displaced by a maximum displacement path, the sliding device can rest against at least one of the shell elements. Advantageously, the length of the displacement path of the upper part of the backrest is limited by the width of the upper part of the backrest along the width axis (Y), which is due to the fact that the runners are arranged within the shell elements or are formed by them.

Advantageously, the sliding device is fixedly arranged on the lower part of the backrest on the left-hand side when the occupant is facing forwards. The upper part of the backrest can thus be moved to the left by the occupant turning to the right rear. It has been found that occupants/vehicle drivers usually turn to the right side or to the right rear. Of course, the invention should also include an embodiment in which the sliding device is fixedly arranged on the lower part of the backrest on the right-hand side. It would also be conceivable for the sliding device to be arranged centrally on the lower part of the backrest. This would allow movement to the left as well as to the right. Since the shell elements are advantageously designed to be symmetrical, they can be used for both right and left turns. Preferably, only the mounting location of the sliding device on the lower part of the backrest determines which direction of rotation is supported for the occupant.

According to another advantageous embodiment, the runners are curved so that the upper part of the backrest can be moved along a curved displacement curve. Advantageously, the displacement curve is circular around the height axis (Z). The curved displacement curve preferably follows the curved direction described above, which lies in a plane spanned by the width axis (Y) and the longitudinal axis (X). Advantageously, a component of the curved displacement curve along the width axis (Y) is greater than a component along the longitudinal axis (X). Such a curved displacement curve continues to provide the occupant with a certain amount of support from the upper part of the backrest during the rotational movement.

Advantageously, the shell elements have a curvature. The curvature of the shell elements can essentially correspond to the curvature of the runners or differ from the curvature of the runners. The curvature of the shell elements, in particular the curvature of the front shell element, is designed in accordance with ergonomic considerations.

According to another advantageous embodiment, each of the runners is assigned at least one sliding element of the sliding device. Advantageously, two sliding elements are assigned to each runner. Preferably, these two sliding elements are spaced apart from each other along the width of the sliding device. The advantageous sliding elements contact the associated runners and can slide along the runners. The sliding device and its sliding elements are fixed relative to the lower part of the backrest.

Advantageously, the runners and the associated sliding elements form an inclined bearing arrangement. Preferably, the runners and the associated sliding elements form an O-arrangement. Such an O-arrangement provides maximum possible tilt rigidity. The sliding device and the shell elements enclosing it with the runners essentially constitute a profile rail guide. With an advantageous inclined bearing, the arrangement of the sliding device and the enclosing shell elements is comparable to a profile rail guide comprising a double-sided dovetail profile rail. Preferably, the sliding device comprises two upper sliding elements along the height axis (Z). These are arranged on opposite sides of the sliding device. The upper sliding elements advantageously comprise contact surfaces which run obliquely upwards and outwards along the height axis Z. The contact surfaces of the upper sliding elements thus form an angle γ with an axis that runs parallel to the centre line of the sliding device. The angle γ lies in a range between 30° and 50°. The contact surfaces of the upper sliding elements therefore advantageously form a V-shape that is essentially open at the top along the height axis (Z).

Preferably, the sliding device comprises two lower sliding elements along the height axis (Z). These are arranged on opposite sides of the sliding device. The lower sliding elements advantageously comprise contact surfaces which run diagonally downwards and outwards along the height axis Z. The contact surfaces of the lower sliding elements thus form an angle γ with an axis that runs parallel to the centre perpendicular of the sliding device. The angle γ is in a range between 30° and 50°. Advantageously, a first of the lower sliding elements is arranged along the height axis (Z) offset from the second of the lower sliding elements.

According to another advantageous embodiment, there is essentially linear contact between the at least one sliding element and the runner. Preferably, the at least one sliding element has a contact surface which contacts an associated runner. The contact surface is preferably barrel-shaped. Such a barrel-shaped design has a curvature that is greatest in the centre. Such a barrel-shaped contact surface offers the advantages of minimal surface pressure and maximum deformation difference.

According to another advantageous embodiment, a first subset of the inner runners is formed by strip elements. Preferably, the strip elements are arranged on one of the shell elements. Advantageously, at least one elastic element is arranged between a strip element and a shell element. Preferably, the at least one elastic element is designed to press the respective strip element in a flexible manner against the sliding device. Advantageously, the at least one elastic element is a flexible wave or leaf spring, which extends along the runner. It would also be conceivable for the at least one elastic element to be an elastic polymer or a suitably designed elastic element of another type.

According to another advantageous embodiment, one runner of the front shell element and one runner of the rear shell element form a runner pair. Preferably, one runner of such a runner pair belongs to the first subset. Preferably, the respective second runner of such a runner pair belongs to a second subset of inner runners. The runners belonging to the second subset are advantageously formed on an inner side of one of the shell elements or integrated into this inner side or formed by an external element which is attached to an inner side of one of the shell elements. The runners from the second subset thus preferably do not have any elastic element. An advantageous pair of runners thus consists of a runner which is formed as a strip element that is pressed against the sliding device and a runner which is arranged on an inner side of a shell element or formed by it. The two runners of a pair of runners can preferably be arranged at the same height along the height axis (Z). It would also be conceivable for both runners of a runner pair to be arranged offset along the height axis (Z) at different heights along the height axis (Z).

According to another advantageous embodiment, the shell elements have different stiffnesses. Preferably, the stiffnesses of the shell elements are designed such that the front runners or the rear runners are pressed against the sliding device.

According to another advantageous embodiment, the shell elements have second reinforcement elements, which are provided at least in sections of the shell elements in which the runners are arranged or formed. The second reinforcement elements thus give the shell elements increased stability in the areas in which the runners are arranged or formed. The shell elements thus exhibit increased stability with regard to forces acting through the runners, for example shear forces and/or bending forces and/or torsional forces. Preferably, the second reinforcement elements are designed as rib elements.

According to a further advantageous embodiment, there is at least one releasable mechanical securing connection in a basic position of the upper part of the backrest and/or a second position of the upper part of the backrest, in which the upper part of the backrest is displaced by a maximum displacement distance. The at least one securing connection can be released again by displacement from the basic position or the second position. The securing connection is preferably designed and suitable for absorbing forces along the height axis (Z). In the basic position or the second position, the sliding device is located on or near an outer side of the shell elements. If a force acts along the height axis (Z) on the opposite outer side, the sliding connection between the runners and the sliding device can be impaired by the lever effect of the runners. The advantageous securing connection ensures that such forces are transferred to the shell elements without damaging the sliding connection., the securing connection preferably comprises at least one protrusion element, which is arranged in at least one supporting element at least in the basic position or at least in the second position. The at least one protrusion element can preferably be arranged on the sliding device or on at least one of the shell elements. Accordingly, at least one supporting element can preferably be arranged on at least one of the shell elements or on the sliding device.

According to another advantageous embodiment, the upper part of the backrest is in a latching position in the basic position and/or in the second position. The upper part of the backrest can preferably be moved out of the latching position by applying increased force. In this latching position, there is a latching connection between the sliding device and at least one of the shell elements. Advantageously, the sliding device and at least one of the shell elements comprise corresponding locking elements. Preferably, a latching mechanism is integrated into the securing connection. However, a latching mechanism separate from the securing connection would also be conceivable.

According to a further preferred embodiment, a return device is provided which automatically returns the at least one backrest upper part to the basic position.

According to a further preferred embodiment, a locking device is provided which locks the at least one upper part of the backrest in the second position. The upper part of the backrest returns to the basic position after release, for example after a release movement.

The present task continues to be solved by a commercial vehicle with a vehicle seat according to the embodiments described above. The commercial vehicle can be equipped with all the features already described above in the context of the vehicle seat, either individually or in combination with each other, and vice versa.

The utility vehicle may be an agricultural utility vehicle, a construction machine, a forklift truck, a material handling machine, an industrial truck, or similar.

Further advantages, objectives and characteristics of the present invention are explained in the following description of the accompanying figures. Similar components may have the same reference symbols in the various embodiments.

### BRIEF DESCRIPTION OF THE DRAWINGS

The figures show:

FIG. 1 a front view of a backrest upper part according to one embodiment;

FIG. 2 a top view of a backrest upper part according to one embodiment;

FIG. 3 a side view of a backrest upper part according to one embodiment;

FIG. 4 a front view of a backrest upper part according to one embodiment;

FIG. 5 an exploded view of a backrest upper part according to one embodiment;

FIG. 6 an exploded view of a backrest upper part according to one embodiment;

FIG. 7 a front view of a backrest upper part according to one embodiment;

FIG. 8 a sectional view of an upper part of the backrest according to one embodiment;

FIG. 9 a top view of a backrest upper part according to one embodiment;

FIG. 10 a sectional view of an upper part of a backrest according to one embodiment;

FIG. 11 a sectional view of an upper part of the backrest according to one embodiment;

FIG. 12 a sectional view of an upper part of a backrest according to one embodiment;

FIG. 13 a front view of a backrest upper part according to one embodiment;

FIG. 14 a sectional view of a backrest upper part according to one embodiment;

FIG. 15 an exploded view of a backrest upper part according to one embodiment;

FIG. 16 a partial view of an upper part of the backrest according to one embodiment;

FIG. 17 a partial view of a backrest upper part according to one embodiment;

FIG. 18 a partial view of a backrest upper part according to one embodiment;

FIG. 19 a vehicle seat according to one embodiment;

FIG. 20 a schematic representation;

FIG. 21 a schematic representation; and

FIG. 22 a schematic representation.

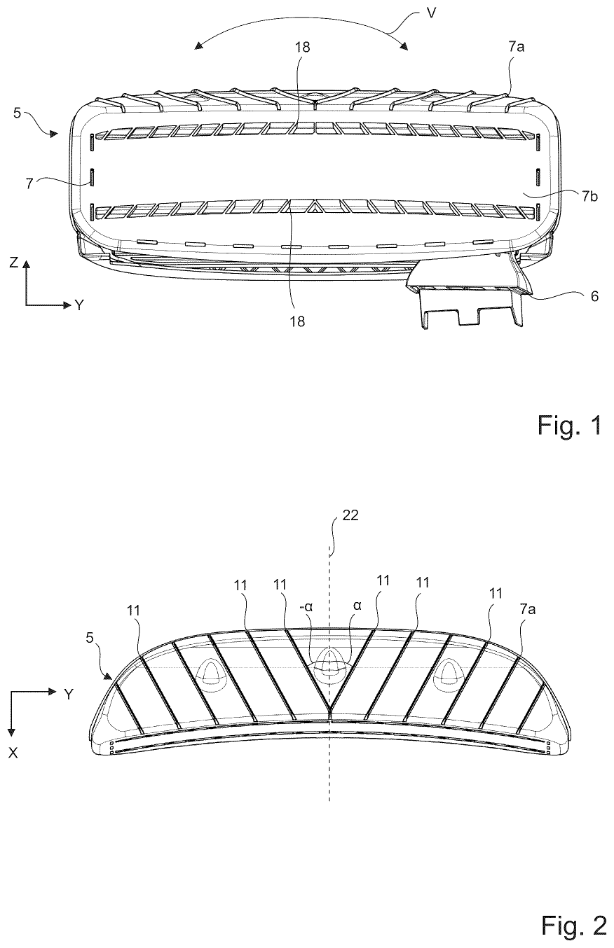

### DETAILED DESCRIPTION

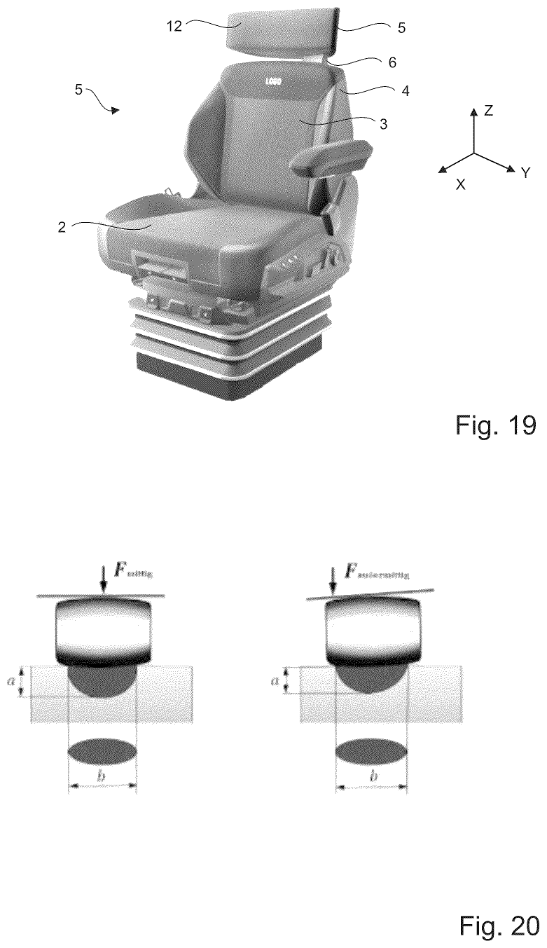

FIG. 19 shows a vehicle seat 1, in particular for a commercial vehicle. The vehicle seat 1 comprises a seat part 2 and a backrest 3, which comprises a lower part of the backrest 4 and an upper part of the backrest 5, wherein the upper part of the backrest 5 is displaceable relative to the lower part of the backrest 4, wherein a sliding device 6 is fixedly arranged on the lower part of the backrest 4, wherein the backrest upper part 5 at least partially encloses the sliding device 6 and is arranged to be displaceable along the latter in a direction of displacement V, wherein the backrest upper part 5 comprises two shell elements 7, 8 which are firmly connected to one another and between which the sliding device 6 is arranged, wherein at least two inner runners 9, 10 are arranged on each of the shell elements 7, 8 or formed by the respective shell element 7, 8, wherein the sliding device 6 contacts the inner runners 9, 10 and can slide along them.

The vehicle seat 1 extends along a height axis Z, a longitudinal axis X and a width axis Y. The respective axes are perpendicular to each other. The longitudinal axis X extends along the (driving) direction in which the occupant is usually oriented towards the front, i.e. towards the controls such as the steering wheel, etc. The backrest 3 is arranged in a rear area of the seat part 2 along the longitudinal axis X or behind the seat part 2 along the longitudinal axis X. Furthermore, the backrest 3 extends upwards from the seat part 2 along the height axis Z. For simplicity, it is assumed that the backrest 3 extends along the height axis Z. Of course, the backrest 3 can be designed to be tiltable and thus inclined to the height axis Z. Accordingly, the vehicle seat 1 can comprise an adjustment device for the inclination of the backrest 3. The vehicle seat may also comprise armrests. FIG. 19 shows a vehicle seat with only one armrest. The backrest 3 comprises a lower part of the backrest 4 and an upper part of the backrest 5. FIG. 19 shows the upper part of the backrest 5 in its basic position.

At least two runners 9, 10 are arranged on each shell element 7, 8 or are formed by it, whereby the sliding device 6 contacts the runners 9, 10 and can slide along them. The upper part of the backrest 5 comprises a front shell element 7 and a rear shell element 8. The front shell element 7 comprises an upper section 7a and a support section 7b. The support section 7b connects to the upper section and forms an angle β with it. The angle β is preferably in a range between 75° and 115°, more preferably between 85° and 110°. At least one padding element 12 is arranged at least in sections on the front shell element 7( ). The at least one padding element 12 may be arranged only on the support section 7b or may cover both the support section 7b and the upper section 7a. Preferably, the at least one padding element 12 comprises at least one padding layer and, if desired, a cover.

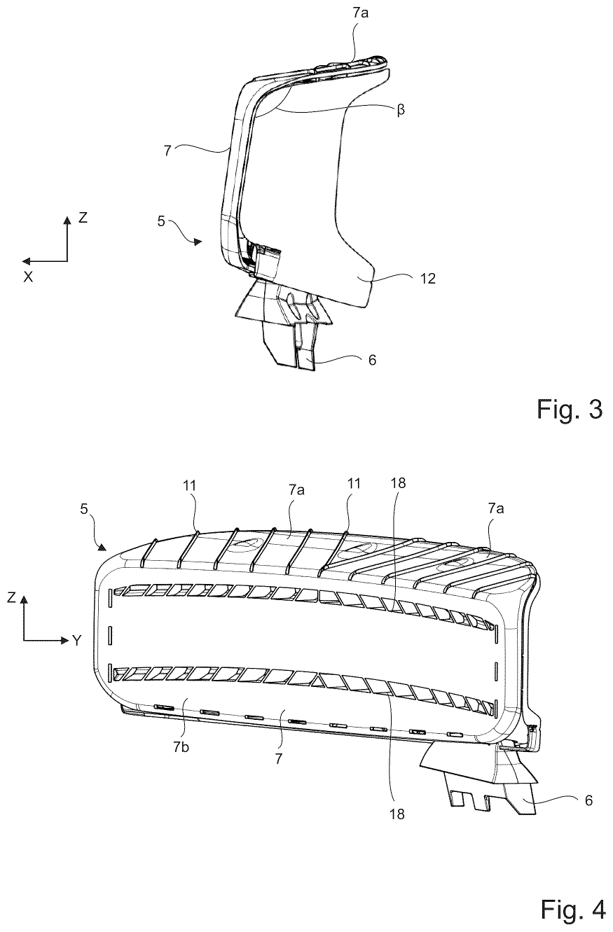

Furthermore, a cover element 12 is arranged on the rear shell element 8. The cover element 12 has a substantially C-shaped cross-section, as can be seen, for example, in FIG. 3.

The upper section 7a of the front shell element 7 extends along the longitudinal axis X towards the rear over the sliding device 6, the rear shell element 8 and the cover element 12. It is conceivable that the rear shell element 8 and/or the cover element 12 are attached to the upper section. It is conceivable that the rear shell element 8 and/or the cover element 12 rest against the upper section 7a without being explicitly fastened.

The front shell element 7 and the rear shell element 8 each have an upper edge area 7c, 8a and a lower edge area 7d, 8b. The upper edge area 7c, 8a of the respective shell element 7, 8 is spaced apart from the lower edge area 7d, 8b of the respective shell element 7, 8 along the height axis Z. Furthermore, the front shell element 7 and the rear shell element 8 each have a right-hand side edge area 7e, 8c and a left-hand side edge area 7f, 8d. The right-hand side edge area 7e, 8c of the respective shell element 7, 8 is spaced apart from the left-hand side edge area 7f, 8d of the respective shell element 7, 8 essentially along the width axis Y.

The front shell element 7 and the rear shell element 8 are firmly connected at their upper edge areas 7c, 8a, as well as at their right-hand side edge areas 7e, 8c and their left-hand side edge areas 7f, 8d. For this purpose, material-locking and/or form-locking connections can be used, for example. For example, screw connections or hot rivet connections can be considered. The lower edge areas 7d, 8b of the two shell elements 7, 8 are not connected. These two lower edge areas 7d, 8b are spaced apart in such a way that the sliding element 6 is arranged here in a displaceable manner. A clearance 21 is created between the two shell elements 7, 8, in which the sliding element 6 is arranged so that it can be displaced. Connecting devices 27 may be provided at the upper edge areas 7c, 8a and at the lateral edge areas 7e, 7f, 8c, 8d. These may be, for example, bores, grooves, threads, etc.

The sliding device 6 is arranged in a lateral area of the lower part of the backrest 4. In FIG. 19, the sliding device 6 is arranged on the left-hand side when viewed from the front by the occupant. The occupant can move the upper part of the backrest 5 accordingly by turning to the right. This can be done, for example, with the upper arm.

The lateral direction of displacement (V) lies in a plane spanned by the width axis Y and a longitudinal axis X. The lateral direction of displacement (V) can extend in a straight line along the width axis Y or run along a curved direction in the plane. Such a curved direction of displacement thus comprises a component along the width axis Y and a component along the longitudinal axis X. In the present case, the lateral direction of displacement V is to extend essentially along the width axis Y. This means that the component along the longitudinal axis X is significantly smaller than the component along the width axis Y. Such a curved displacement path can also be understood as a rotational movement about the height axis Z, whereby the radius of curvature is large.

The inner runners 9, 10 are curved so that the upper part of the backrest 5 can be moved along the curved displacement curve. The shell elements 7, 8 are also curved. The curvature of the shell elements 7, 8 may, but need not, correspond to the curvature of the runners. In particular, the curvature of the front shell element 7 is designed with ergonomic considerations in mind.

Due to the curvature of the runners 9, 10, the upper part of the backrest 5 moves along the curved displacement curve. Advantageously, the curved displacement curve is circular around the height axis Z. As a result, the upper part of the backrest 5 follows the natural rotational movement of the occupant and also allows the occupant to fall in a twisted sitting position.

First reinforcement elements 11 in the form of rib elements are arranged on the upper section 7a of the front shell element 7. The rib elements are arranged in two areas. The two areas are separated by a centre axis 22, which runs centrally through the upper section 7a of the front shell element 7. Within these areas, the respective rib elements 11 are arranged essentially parallel to each other. The rib elements 11 in the first area form an angle α with an axis that runs parallel to the centre axis M. Advantageously, the angle α lies in a range between 10° and 60°, preferably in a range between 20° and 45°. In the second area, the respective rib elements 11 form an angle-α with an axis that runs parallel to the centre axis 22. The rib elements 11 of the second range thus advantageously form an angle which lies in a range between −10° and −60°, preferably in a range between −20° and −45°.

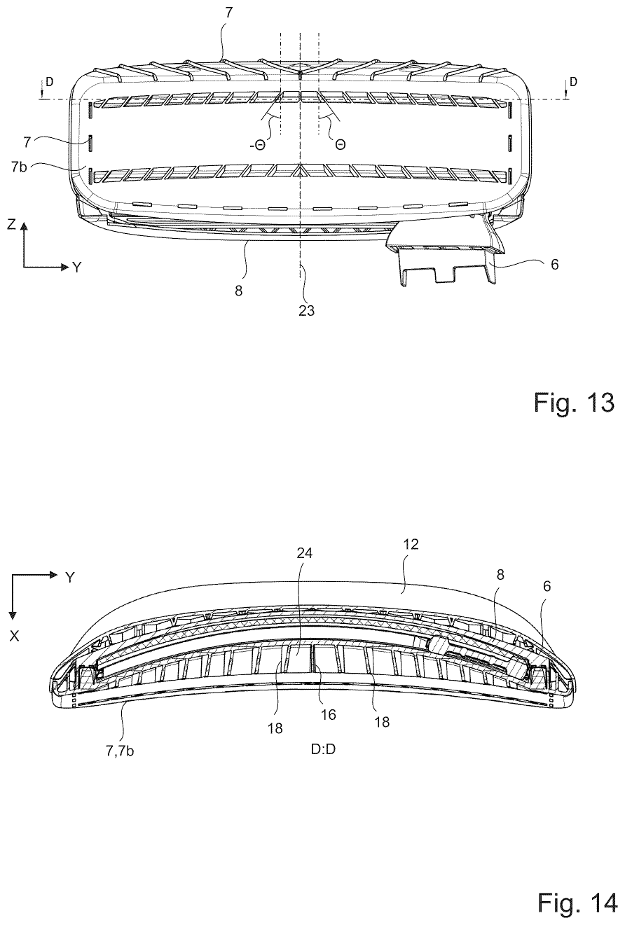

The shell elements 7, 8 may have second reinforcement elements 18, which are provided in sections of the shell elements 7, 8 in which the runners 9, 10 are arranged or formed. Such reinforcement elements 18 may be designed as rib elements. FIG. 14 shows a section along the axis D:D of FIG. 13. Here, the reinforcement elements 18 are clearly visible. There are spaces between the reinforcement elements 18. The reinforcement elements 18 are also arranged in two areas. The two areas are separated by a centre axis 23, which runs centrally through the support section 78 of the front shell element 7. In the respective areas, the rib elements 18 run essentially parallel to each other. The rib elements 18 in the first area form an angle θ with an axis that runs parallel to the centre axis 23. Advantageously, the angle θ lies in a range between 10° and 60°, preferably in a range between 20° and 45°. In the second area, the respective rib elements 18 form an angle −θ with an axis that runs parallel to the centre axis 23. The rib elements 18 of the second range thus advantageously form an angle which lies in a range between −10° and −60°, preferably in a range between −20° and −45°.

Furthermore, the rib elements 18 extend rearward along the longitudinal axis X. A cross-section of the rib elements 18 increases rearward along the longitudinal axis X. An inner wall element 24 is provided at a rear end of the rib elements 18, on which the front runners 9 are arranged or formed.

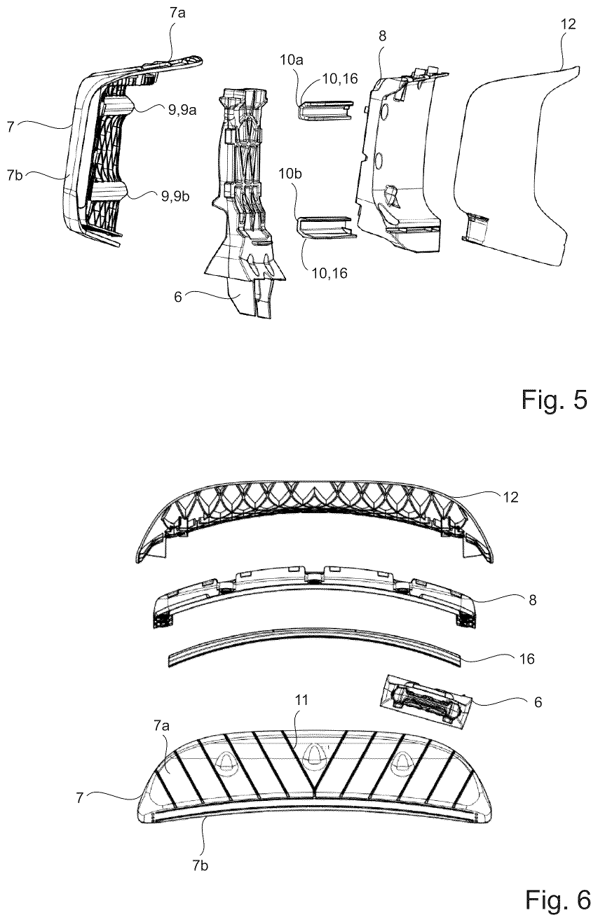

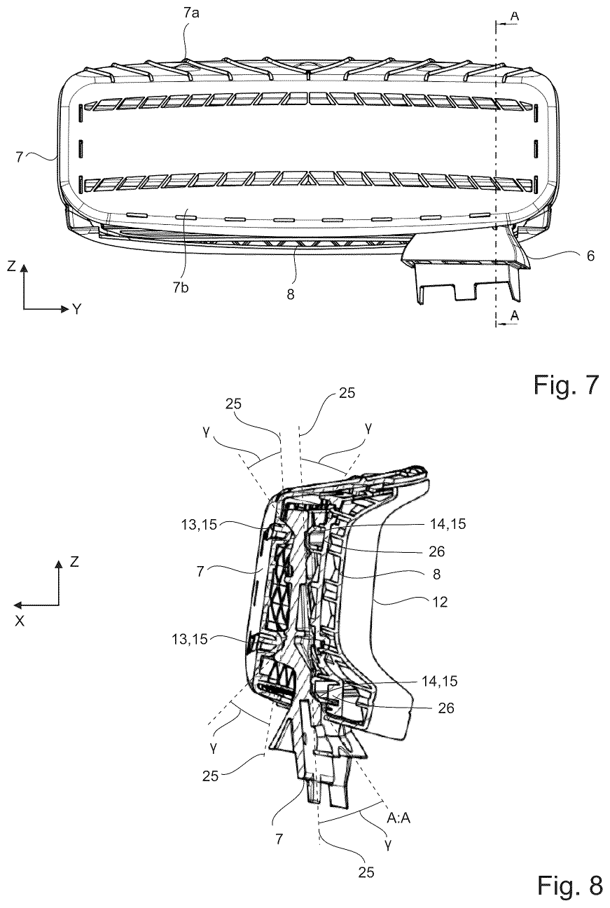

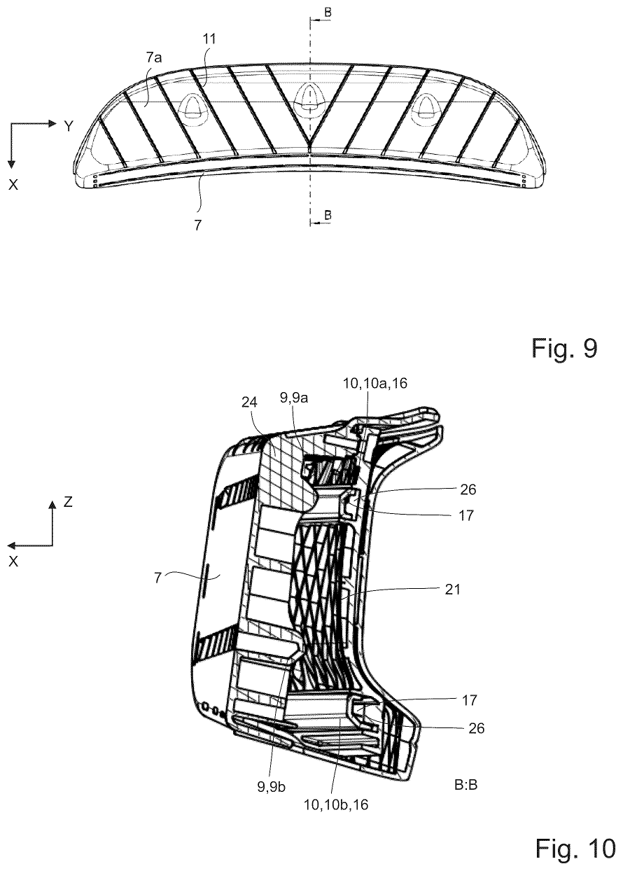

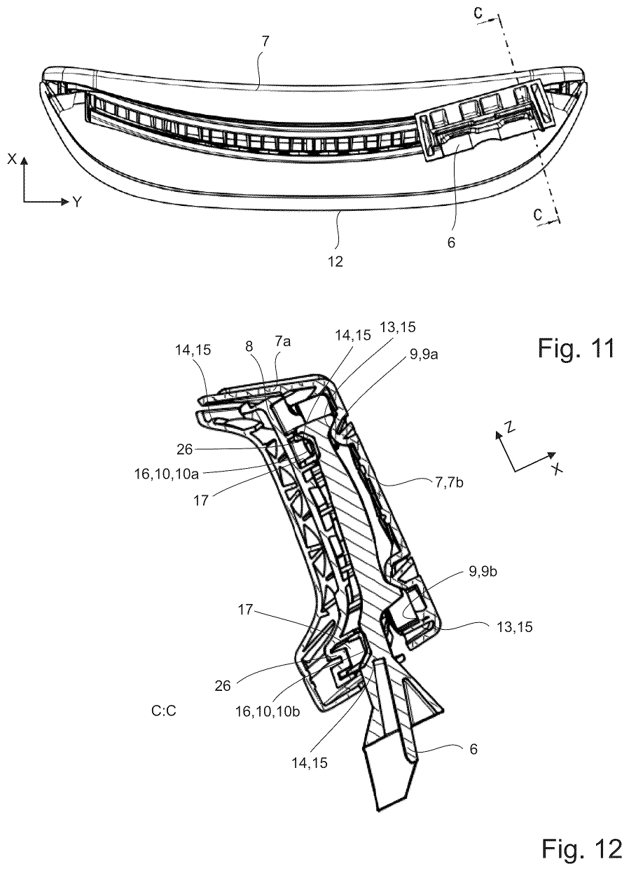

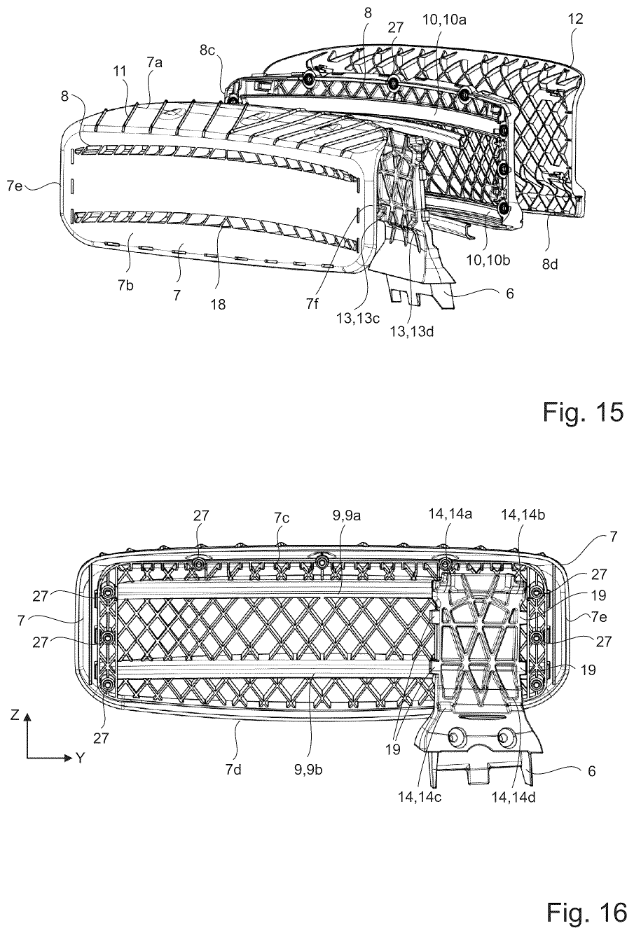

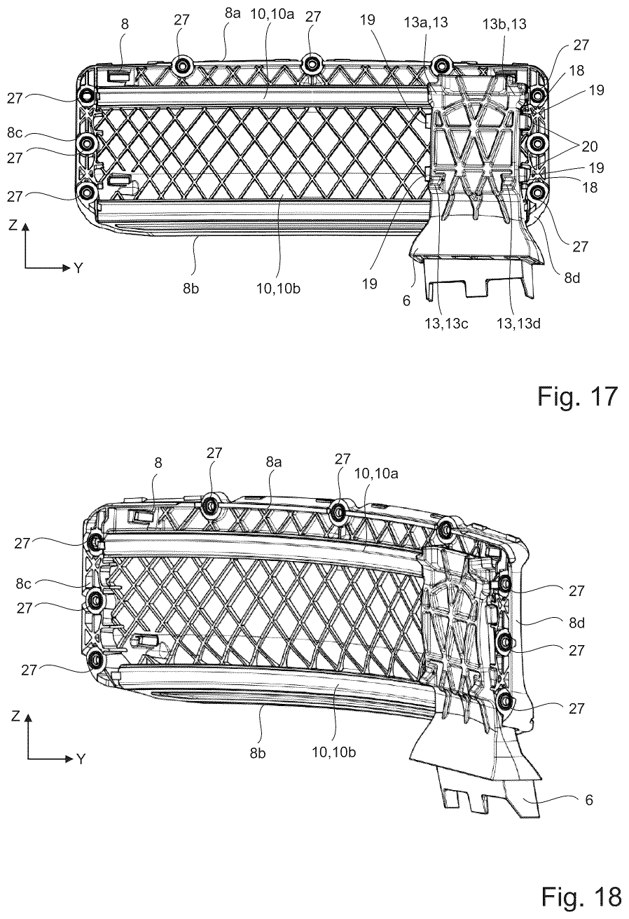

As can be clearly seen in FIGS. 5, 8, 10, 12 and 15 to 18, the present embodiment comprises four runners 9, 10. There are two front runners 9, which are arranged on the front shell element 7 or integrated into its inner wall element 24. The two front runners 9 are spaced apart from each other along the height axis Z. There are also two rear runners 10, which are arranged on the rear shell element 8. The rear runners are also spaced apart from each other along the height axis Z. In the present embodiment, the runners 9, 10 are also formed continuously along essentially the entire width of the shell elements 7, 8.

At least one sliding element 13, 14 of the sliding device 6 is assigned to each of the runners 9, 10. Front sliding elements 13 are provided on the sliding device 6, which are assigned to the front runners 9 of the front shell element 7. Furthermore, rear sliding elements 14 are provided on the sliding device 6, which are assigned to the rear runners 10 of the rear shell element 8. Furthermore, two sliding elements 13, 14 are assigned to each of the runners 9, 10. The sliding device 6 thus comprises four front sliding elements 13 and four rear sliding elements 14. The sliding elements 13, 14 associated with a respective runner are spaced apart along the width axis Y and are each arranged at an opposite lateral edge area of the sliding device 6. However, it would also be conceivable to provide a continuous sliding element or more than two sliding elements.

In the present case, a first front sliding element 13a and a second front sliding element 13b are assigned to the upper front runner 9, 9a. A third front sliding element 13c and a fourth front sliding element 13d are assigned to the lower front runner 9, 9b. Furthermore, a first rear sliding element 14a and a second rear sliding element 13b are assigned to the upper rear runner 10, 10a. A third rear sliding element 14c and a fourth rear sliding element 14d are assigned to the lower rear runner 10, 10b.

The runners 9, 10 and the associated sliding elements 13, 14 represent an angled bearing arrangement with an O-arrangement. The sliding device 6 and the shell elements 7, 8 surrounding it with the runners 9, 10 essentially represent a profile rail guide. With an advantageous angled bearing, the arrangement of the sliding device 6 and the surrounding shell elements 7, 8 with a profile rail guide comprising a double-sided dovetail profile rail is comparable. Such a basic O arrangement is shown in FIG. 21. Such an O arrangement provides maximum possible tilt stiffness, as a large number of torques (for example, the torque M in FIG. 21) are blocked by the arrangement.

The sliding elements 13, 14 comprise inclined contact surfaces 15 which contact the associated runners 9, 10. The sliding elements 13a, 13b, 14a, 14b, which are associated with the respective upper runners 9a, 10a, are referred to below as upper sliding elements. The upper sliding elements 13a, 13b, 14a, 14b comprise contact surfaces 15 which run obliquely upwards and outwards along the height axis Z. The contact surfaces 15 of these upper sliding elements 13a, 13b, 14a, 14b thus form an angle γ with an axis 25 which runs parallel to the centre line of the sliding device 6. The angle γ lies in a range between 30° and 50°. The sliding elements 13c, 13d, 14c, 14d, which are assigned to the respective lower runners 9b, 10b, are referred to below as lower sliding elements. The lower sliding elements 13c, 13d, 14c, 14d comprise contact surfaces 15 which run obliquely downwards and outwards along the height axis Z. The contact surfaces 15 of the lower sliding elements 13c, 13d, 14c, 14d thus form an angle γ with an axis 25 which runs parallel to the centre perpendicular of the sliding device 6. The angle γ lies in a range between 30° and 50°. The aforementioned angle γ can be the same for all contact surfaces 15 of the sliding elements 13, 14. It would also be conceivable for the angle γ to be the same only for the sliding elements 13, 14 which are assigned to a specific runner 9, 10.

There is essentially linear contact between the sliding elements 13, 14 and the corresponding runner 9, 10. Preferably, the sliding elements 13, 14 comprise a contact surface 15 which has a curvature. In particular, the sliding elements 13, 14 have a contact surface 15 which has a barrel-shaped curvature. Such a barrel-shaped design of the contact surface results in an essentially linear contact, which, in contrast to a point-shaped contact (e.g. in the case of spherical contact surfaces), results in minimal surface pressure. Furthermore, a barrel-shaped contact surface ensures maximum deformation indifference. This is shown in principle in FIG. 20. Here it can be seen that, in contrast to a central force application, the contact pattern changes only insignificantly when a lateral force is applied.

The upper front sliding elements 13a, 13b are essentially arranged at the same height along the height axis Z as the upper rear sliding elements 14a, 14b. The lower front sliding elements 13c, 13d are arranged along the height axis Z offset above the lower rear sliding elements 14c, 14d.

A first subset of the inner runners 9, 10 is formed by strip elements 16. In this case, these are the rear runners 10, 10a, 10b. However, this should not be taken as a limitation on the generality. The strip elements 16 are arranged on the rear shell element 8. The rear shell element 8 comprises corresponding receptacles 26 for this purpose. At least one elastic element 17 is arranged between a strip element 16 and the rear shell element. The at least one elastic element 17 can be a wave or leaf spring, an elastic polymer or similar. The at least one elastic element 17 preferably extends along the entire width of the runners 10, 10a, 10b. The at least one elastic element 17 provides a preload which presses the respective strip element 16 against the sliding device 6 or the associated sliding element. At the same time, the sliding device 6 is also pressed against the front runners 9.

One runner 9 of the front shell element 7 and one runner 10, 16 of the rear shell element 8 form a runner pair. One runner 10, 16 of each such runner pair belongs to the first subset. In the present case, the upper runners 9a, 10a form a first pair of runners. The rear upper runner 10a is designed as a strip element 16, which is pressed against the sliding elements 14 by at least one elastic element 17. The lower runners 9b, 10b form a second pair of runners. The rear lower runner 10b is designed as a strip element 16, which is pressed against the sliding elements 14 by at least one elastic element 17.

A similar effect to that achieved by providing the strip elements 16 and the elastic elements 17 can be achieved if the shell elements 7, 9 have different stiffnesses, whereby the stiffnesses of the shell elements 7, 9 are designed in such a way that the front runners 9 or the rear runners 10 are pressed against the sliding device 6.

In the basic position of the upper part of the backrest 5 and/or a second position of the upper part of the backrest 5, in which the upper part of the backrest 5 is displaced by a maximum displacement distance, there is at least one releasable mechanical securing connection 18 between the sliding device 6 and at least one of the shell elements 7. 8. The securing connection 18 is designed and suitable for absorbing forces along the height axis Z. The at least one securing connection can be released again by moving the upper part of the backrest 5 out of the basic position or the second position.

The securing connection 18 comprises at least one protrusion element 19, which is arranged in at least one supporting element 20 at least in the basic position or at least in the second position.

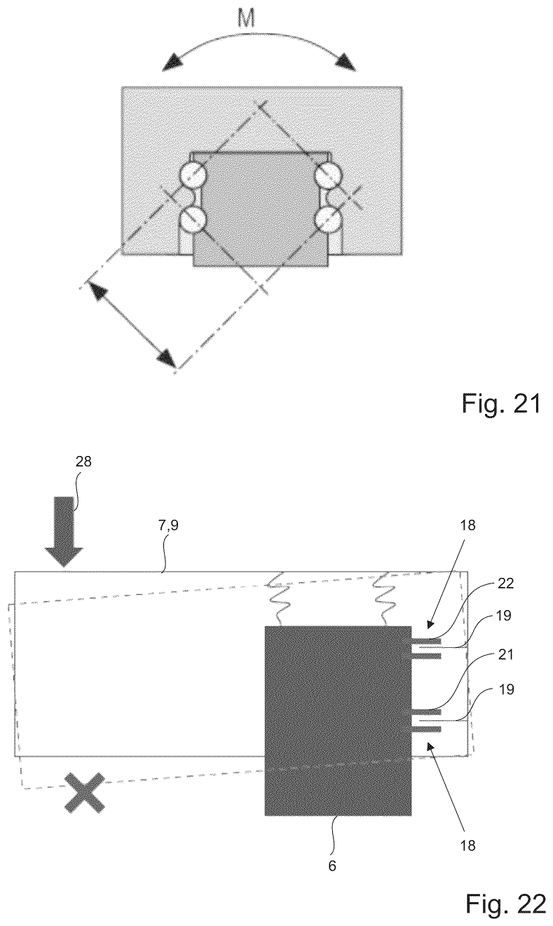

FIG. 22 shows the basic effect of such a securing connection. If the upper part of the backrest 5 is in the basic position or the second position, a force acting along the arrow 28 causes a corresponding lever effect, which causes the shell elements 7, 9 to tilt relative to the sliding device 6. This can impair or damage the shell elements 7, 9 and/or the sliding device 6. The securing connection 18 prevents such tilting and absorbs the corresponding force through the safety device 18.

The protrusion element 19 can be arranged on the sliding device 6 or one of the shell elements 7, 8. Coplanar to this, the supporting element 20 is arranged on one of the shell elements 7, 8 or on the sliding device 6. The supporting element 20 consists of at least an upper and a lower wall section which contact the protrusion element 19. When the protrusion element 19 is located in the supporting element 20, their contact prevents the two elements 19, 20 from tilting relative to each other.

The present invention offers a novel approach to designing a system for assisting the driver in performing reverse and sideways manoeuvres. It essentially aims to significantly reduce the required installation space, expand design options, and significantly simplify construction and reduce manufacturing costs compared to the state of the art.

The approach is based on a new design principle for the linear guidance of the system, essentially along the width axis Y. A type of profile rail guide is provided. The profile rail, consisting of a front and rear half, each with two inner runners 9, 10, is housed in the movable area of the system. The sliding device 6 with four outer runners in the form of sliding elements 13, 14 is placed inside the profile rail and attached to the lower part of the backrest 4. Since the running surfaces of both sliding partners are designed as an O-arrangement, the receptacles for forces and moments in and around the X and Z axes are provided with maximum possible moment and tilt stiffness. To compensate for tolerances and compensate for play and wear between the sliding partners, preload is generated either by the differences in stiffness between the front and rear halves of the profile rail or by incorporating elastically mounted running surfaces in the form of strip elements 16 in the front or rear half of the fictitious profile rail (fixed-loose bearing principle). The new system can thus be designed to be significantly flatter, play-free, and tolerant of tolerances and wear. With complete integration of the profile rail into the surrounding parts using modern manufacturing processes such as injection moulding technology, material efficiency can be increased and manufacturing and assembly processes simplified, which in turn is reflected in a reduction in manufacturing costs.

The applicant reserves the right to claim all features disclosed in the application documents as essential to the invention, provided that they are novel in relation to the prior art, either individually or in combination. It should also be noted that the individual figures also describe features which may be advantageous in themselves. The skilled person will immediately recognise that a particular feature described in a figure may be advantageous even without adopting other features from that figure. Furthermore, the skilled person will recognise that advantages may also result from a combination of several features shown in individual or different figures.

### REFERENCE LIST

1 Vehicle seat
2 Seat part
3 Backrest
4 Lower part of the backrest
5 Upper part of backrest
6 Sliding device
7 Front shell element
7a Upper section
7b Support section
7c Upper edge area of the front shell element
7d Lower edge area of the front shell element
7e Right side edge area of the front shell element
7f Left side edge area of the front shell element
8 Rear shell element
8a Upper edge area of the rear shell element
8b Lower edge area of the rear shell element
8c Right side edge area of the rear shell element
8d Left side edge area of the rear shell element
9 Front runners
9a Upper front runner
9b Lower front runner
10 Rear runners
10a Upper rear runner
10a Lower rear runner
11 First reinforcement elements
12 Cover element
13 Front sliding elements
13a First front sliding element
13b Second front sliding element
13c Third front sliding element
13d Fourth front sliding element
14 Rear sliding elements
15 Contact surface
16 Strip element
17 Elastic element
18 Securing connection
19 Protrusion element
20 Supporting element
21 Clearance
22 Centre axis of the upper section
23 Centre axis of the support section
24 Inner wall element of the front shell element
25 Axis parallel to the centre perpendicular of the sliding device
26 Receptacles
27 Connecting devices
α Angle
β Angle
γ Angle
θ Angle
V Direction of displacement
X Longitudinal axis
Y Width axis
Z Height axis

1. Vehicle seat (10), for a commercial vehicle, comprising:
a seat part (2);
a backrest (3), which comprises a lower part of the backrest (4) and an upper part of the backrest (5), wherein the upper part of the backrest (5) is displaceable relative to the lower part of the backrest (4); and
a sliding device (6) fixedly arranged on the lower part of the backrest (4), wherein the upper backrest part (5) at least partially encloses the sliding device (6) and is arranged to be displaceable along a direction of displacement (V), wherein the upper backrest part (5) comprises two shell elements (7, 8) which are firmly connected to one another, between which the sliding device (6) is arranged, wherein at least two inner runners (9, 10) are arranged on each shell element (7, 8) or are formed by the respective shell element (7, 8), wherein the sliding device (6) contacts the inner runners (9, 10) and can slide along them.

2. Vehicle seat (1) according to claim 1, wherein
the lateral direction of displacement (V) lies in a plane spanned by a width axis (Y) and a longitudinal axis (X).

3. Vehicle seat (1) according to claim 1, further comprising
a front shell element (7) and a rear shell element (8) wherein the front shell element (7) comprises an upper section (7a) which extends rearwards along the longitudinal axis (X) over the sliding device (6), wherein reinforcement elements (11) are arranged on the upper section (7a) reinforcement elements (11) are arranged, wherein the reinforcement elements (11) are designed as rib elements.

4. Vehicle seat (1) according to claim 3, further comprising
at least one upholstery element (12) arranged at least in sections on the front shell element (7), wherein a cover element (12) is arranged on the rear shell element (8).

5. Vehicle seat (1) according to claim 1, wherein
the sliding device (6) is arranged in a lateral area of the lower part of the backrest (4), whereby the inner runners (9, 10) are curved so that the upper part of the backrest (5) can be moved along a curved displacement curve.

6. Vehicle seat (1) according to claim 1, wherein
each of the runners (9, 10) is assigned at least one sliding element (13, 14) of the sliding device (6), wherein the runners (9, 10) and the assigned sliding elements (13, 14) constitute a preloaded bearing, wherein the runners (9, 10) and the associated sliding elements (13, 14) form an O-arrangement.

7. Vehicle seat (1) according to claim 6, wherein
between the at least one sliding element (13, 14) and the runner (9, 10) there is a substantially linear contact, wherein the at least one sliding element (13, 14) has a contact surface (15) which contacts an associated runner (9, 10), wherein the contact surface (15) is barrel-shaped.

8. Vehicle seat (1) according to claim 1, wherein
a first subset of the inner runners (9, 10) is formed by strip elements (16), wherein the strip elements (16) are arranged on one of the shell elements (7, 8), wherein at least one elastic element (17) is arranged between a strip element (16) and a shell element (7, 8), at least one elastic element (17) is arranged, which is designed to press the respective strip element (16) against the sliding device (6).

9. Vehicle seat (1) according to claim 8, wherein
a respective runner (9) of the front shell element (7) and a runner (10, 16) of the rear shell element (8) form a runner pair, wherein a respective runner (10, 16) of such a runner pair belongs to the first subset.

10. Vehicle seat (1) according to claim 1, wherein
the shell elements (7, 9) have different stiffnesses, wherein the stiffnesses of the shell elements (7, 9) are designed such that the front runners (9) or the rear runners (10) are pressed against the sliding device (6).

11. Vehicle seat (1) according to claim 1, wherein
the shell elements (7, 8) have second reinforcement elements (18) which are provided at least in sections of the shell elements (7, 8) in which the runners (9, 10) are arranged or formed.

12. Vehicle seat (1) according to claim 1, wherein
in a basic position of the upper part of the backrest (5) and/or a second position of the upper part of the backrest (5), in which the upper part of the backrest (5) is displaced by a maximum displacement distance, at least one releasable mechanical securing connection (18) exists between the sliding device (6) and at least one of the shell elements (7, 8), wherein the at least one securing connection (18) is intended and suitable for absorbing forces acting along the height axis (Z), wherein the securing connection (18) comprises at least one protrusion element (19) which, at least in the basic position or at least the second position, is arranged in at least one supporting element (20).

13. Commercial vehicle with a vehicle seat according to claim 1.

14. A Vehicle seat (1) for a commercial vehicle, comprising:
a seat part (2);
a backrest (3) including a lower part (4) and an upper part (5), the upper part (5) having two shell elements (7, 8) firmly connected to one another;
at least two runners (9, 10) extending along each shell element (7, 8) of the upper part (5); and
a sliding device (6) fixedly arranged on the lower part (4) and being at least partially enclosed by the two shell elements (7, 8), the sliding device (6) being coupled to the at least two runners (9, 10) on each shell element (7, 8) for sliding movement of the upper part (5) along a direction of displacement (V) relative to the lower part (4).
